(19) United States
(12) Patent Application Publication
(10) Pub. No.: US 2004/0205142 A1
(43) Pub. Date: Oct. 14, 2004

(54) Notification filtering apparatus, systems, and methods

(75) Inventor: Casey Bahr, Hillsboro, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/336,339

(22) Filed: Jan. 2, 2003

(51) Int. Cl. G06F 15/16; G06F 9/46

(52) U.S. Cl. 709/207; 719/318

(57) ABSTRACT

An apparatus and a system may include a plurality of filter stages including at least two of an event filter stage, a subscription filter stage, and a subscriber filter stage. They may also include a subscriber capable of being communicatively coupled to a managed object via the plurality of filter stages, wherein the managed object is associated with a notification of an event capable of propagating through the plurality of filter stages to the subscriber. An article may include data, which, when accessed, results in a machine performing a method including detecting the occurrence of an event associated with a change in a managed object and propagating a notification of the event to a subscriber through a plurality of filter stages.

### TECHNICAL FIELD

Embodiments of the invention relate generally to apparatus, systems, and methods used to manage the propagation of information within computer systems, including information relating to the occurrence of events in platforms governed by processors.

### BACKGROUND INFORMATION

Platform management systems, including those known as Operations, Administration, and Maintenance (OA&M) systems, can be used to monitor and control platform activity, as well as to diagnose performance problems associated with the occurrence of various platform events. In such systems, the ability to consistently and reliably propagate information relating to the occurrence of events arising from changes in platform-managed objects is often desirable. This is especially true in environments where consumers demand robust event-related notification management, such as when increasingly sophisticated, handheld wireless clients, including Personal Digital Assistants (PDAs) and cellular telephones, are used. Improved control over the propagation and consumption of platform event-related information may help to achieve these goals.

### BRIEF DESCRIPTION OF THE DRAWINGS

FIG. 1 is a block diagram of an apparatus, an article including a machine- accessible medium, and a system, according to various embodiments of the invention; and

FIG. 2 is a flow chart illustrating several methods, according to various embodiments of the invention.

### DETAILED DESCRIPTION

In the following detailed description of various embodiments of the invention, reference is made to the accompanying drawings that form a part hereof, and in which are shown by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. The following detailed description, therefore, is not to be taken in a limiting sense, and the scope of various embodiments of the invention is defined only by the appended claims, along with the full range of equivalents to which such claims are entitled.

Embodiments of the invention include apparatus, systems, articles, and methods for filtering events, alarms, and notifications. Some embodiments may be implemented within an OA&M infrastructure. For the purposes of this disclosure, the following definitions should be observed:

AGENT: a process or task within a platform that may initialize and/or modify filters and/or subscriptions

ALARM: a type of notification that may represent anomalous platform behavior, including system faults

DISCRIMINATOR: may be considered the smallest unit of a filter, such as a particular rule or delivery policy for use in a specific situation

EVENT: may include a spontaneous, scheduled, or humanly-directed change in a platform-managed object; events may also be the result of a temporary or persistent condition and generated as a part of normal platform operations, diagnostics, surveillance, and/or out of tolerance conditions

FILTER: may comprise a module made up of one or more discriminators, operating to evaluate and/or enable/disable the propagation of an indication of information relating to an event, including a notification, and/or an alarm within a platform

NOTIFICATION: may include a message sent to interested platform entities as a manifestation of an event

PLATFORM: includes any type of computer, known or hereafter invented, such as wired or wireless handheld devices, including PDAs and cellular telephones, devices having embedded processors, desktop computers and workstations, and networked devices, including computers, printers, storage devices, terminals, wireless communication apparatus, etc.

REPOSITORY: may comprise a module containing managed objects representing or associated with platform resources, including memory, ports, etc.

SUBSCRIBER: may be a consumer of notifications.

Embodiments of the invention provide multiple levels of control (i.e., granularity) with respect to how events and subsequent notifications are propagated within a platform, or within an OA&M infrastructure associated with a platform. Recognition of the occurrence of events (e.g., indications or information related to the occurrence of an event) can be enabled or disabled, as well as the subsequent propagation of notifications associated with recognition of the occurrence of events, using filter specifications attached to managed objects associated with the events. Propagation may also be enabled/disabled based on characteristics specified by the notification subscriber as well as internal to the subscriber itself Thus, control over event recognition and propagation can be exercised by agents that have knowledge (either local or global) of the context within which notification may occur. Thus, at each level, propagation of information related to any particular event can be filtered.

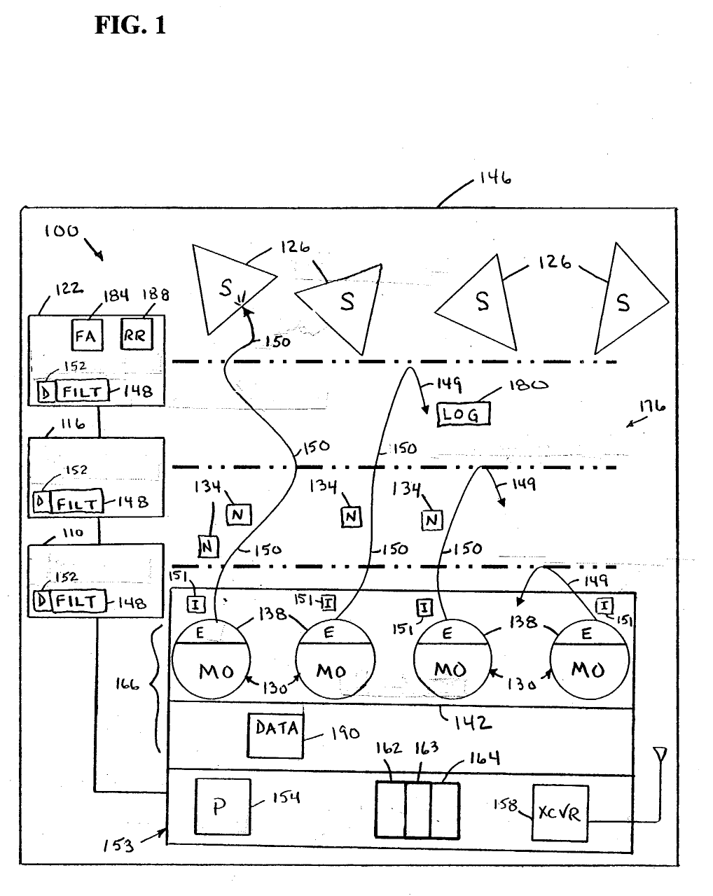

FIG. 1 is a block diagram of an apparatus, an article including a machine- accessible medium, and a system, according to various embodiments of the invention. The apparatus 100 may include a plurality of filter stages 110, 116, 122. Such stages 110, 116, 122 may be of various types, including, for example, any number of an event filter stage 110, a subscription filter stage 116, and/or a subscriber filter stage 122. In most embodiments, at least two such stages 110, 116, 122 will be included in the plurality of filter stages 110, 116, 122.

The apparatus 100 may also include one or more subscribers 126 capable of being communicatively coupled to one or more managed objects 130 via the plurality of filter stages 110, 116, 122. Each managed object 130 maybe associated with one or more notifications 134, which may arise upon the occurrence of one or more events 138. Depending on the composition of the individual filter stages 110, 116, 122, information related to each of the events 138 may be capable of propagating through the filter stages 110, 116, 122 to one or more of the subscribers 126. The managed objects 130 may be included in a managed object repository 142.

Each filter stage 110, 116, 122 may include one or more filters 148 used to enable or disable the creation of a notification 134 of an occurrence of the event. The filters 148 may also be used to enable/disable the passage of notifications 134 to higher-level stages and eventually, to the subscribers 126. As shown in FIG. 1, for example, a filter 148 may be included in the event filter stage 110 to disable 149 or enable 150 delivery of information or an indication 151 of the occurrence of an event 138 to the next filter stage level (e.g., subscription filter stage 116), and ultimately to one or more subscribers 126. Similarly, a filter 148 may be included in the subscription filter stage 116 to disable 149 or enable 150 delivery of one or more notifications 134 of one or more events 138 to the next filter stage level (e.g., subscriber filter stage 122), and ultimately, to one or more subscribers 126. Each filter 148 may include one or more discriminators 152.

In order to illustrate examples of the variety of relationships that may exist within a platform 146, such as the correspondence between platform resources 153, associated managed objects 130, events 138 associated with the managed objects 130, and notifications 134 that may arise from occurrence of such events 138, Table I is provided below:

TABLE I

| | | | |
|---|---|---|---|
| Platform | Characteristics Represented by | | |
| Resources | Associated Managed Objects | Events | Notifications |

| | | | |
|---|---|---|---|
| Flash Memory | Physical characteristics: type, size, bus speed, | Checksum | Out of memory |
| | manufacturer, etc. | error, | condition, |
| | Dynamic characteristics: clock speed, power | High water mark | Memory re- |
| | profile, high-water mark, partitions | moved, | configuration, |
| | | New memory | Fragmentation |
| | | inserted | alarm |
| Processor | Physical characteristics: type, manufacturer, | Cache miss, | Performance |
| | min/max speed, cache size, specific features | Speed change, | profile, |
| | enabled or disabled | Voltage change, | Power usage |
| | Dynamic characteristics: voltage, current, | Temperature | profile, |
| | MHz, temperature, cache misses, protection | limit | Overheating |
| | mode, etc. | | alarm |
| USB Port | Physical: type, manufacturer, specification | Connect, | Bandwidth |
| | level, form factor. | Disconnect, | profile, Error |
| | Dynamic: Connected/Disconnected, actual | Transmit, | profile, New |
| | bandwidth, transmission/reception errors, | Receive | connection |
| | device header (when connecting) | | alarm |
| Calendar | Physical characteristics: manufacturer, | Open/close | Synchronize, |
| Application | version, installed location, installed | application, | Notify new |
| | configuration (e.g., custom, minimal, full), | New entry, | appt., |
| | support level, owner. | Delete entry, | Match UI to |
| | Dynamic: data paths, number of entries. | Change | bandwidth |
| | logging attributes, synchronization policy, | connectivity | |
| | network connectivity, etc. | | |
| Network Storage | Physical: Service Provider, Service version, | Connect, | Service access, |
| Service | Service level, Date started, etc. | Disconnect, | Service usage, |
| | Dynamic: Current storage used, | Timer alarm, | Reminders, |
| | Maximum storage, Last storage profile, User | Exceeds storage | Billing requests |
| | preferences | limit | |

It should be noted that managed objects may be attributes, whole objects, or object collections representing the listed characteristics and associated with corresponding resources. The items listed in Table I are merely representative of the various types of resources, objects, characteristics, events, and notifications described herein, and embodiments of the invention are not so limited. Thus, platform resources 153 may include any number of modules, including hardware, firmware, software, or combinations of these, such as a processor 154, a wireless communication device 158, including a receiver, transmitter, and/or transceiver, ports 162, applications 163, and storage devices 164, including volatile and nonvolatile memory 166. Similarly, managed objects 130 may be associated with physical characteristics, and/or dynamic characteristics, and/or other characteristics of various platform resources 153.

In an alternative embodiment, a system 146, including a communications device 146, such as a cell phone 146 or a PDA 146, may comprise a processor 154 capable of being communicatively coupled to a memory 166 and a wireless communication device 158. The system 146 may also include a plurality of filter stages 110, 116, 122 capable of being communicatively coupled to the processor 154. As noted above, the plurality of filter stages 110, 116, 122, may include at least two of an event filter stage 110, a subscription filter stage 116, and/or a subscriber filter stage 122.

The system 146 may also include one or more subscribers 126 capable of being communicatively coupled to one or more managed objects 130 via the plurality of filter stages 110, 116, 122. In turn, the managed objects 130 may be associated with one or more notifications 134 of events 138, which may be capable of propagating through the plurality of filter stages 110, 116, 122 to one or more subscribers 126.

The memory 166 may include one or more repositories 142 of managed objects 130. Each filter stage 110, 116, 122 may include one or more filters 148 used to enable 150 or disable 149 creating a notification 134 of an occurrence of the event 138, or passage of notifications 134 to higher-level stages and eventually, to the subscribers 126. As is the case with the apparatus 100, one or more filters 148 may be included in the event filter stage 110 to disable 149 or enable 150 delivery of an indication 151 of the occurrence of an event 138 to the next filter stage level (e.g., subscription filter stage 116), and ultimately to one or more subscribers 126. Similarly, one or more filters 148 may be included in the subscription filter stage 116 to disable 149 or enable 150 delivery of one or more notifications 134 of one or more events 138 to the next higher-level filter stage level (e.g., subscriber filter stage 122), and ultimately, to one or more of the subscribers 126.

The apparatus 100 and system 146 may operate in a variety of ways. For example, information 151 relating to events 138 may flow from managed objects 130 through an abstract OA&M fault management component 176 and the filters 110, 116, 122 at each stage. When an event 138 occurs, any number of filter sets 110, 116, 122 may be attached to the event 138 a priori. In some embodiments, filters 148 may be used to determine whether information 151 related to the event 138 is enabled at all for propagation, and in other embodiments a filter 148 may incorporate discriminators 152 that implement a delivery policy. Thus, information 151 associated with a particular event 138 may be enabled by one filter 148, but a subscriber 126 may not receive a notification 134 if another filter 148 implementing a delivery policy is set to block 149 or re-route (perhaps to an event or notification log 180) the notification 134.

At other levels of filtering there may be an optional subscription filter 148 under control of the notification subscriber 126, such as a filter 148 included in the subscriber filter stage 122. At this level, discriminators 152 may be used to filter categories of events 138 with some finer discrimination possible via the implementation of other discriminators 152 which filter on a particular delivery policy. Thus, a subscriber 126 may attach to a category of events 138 (either a priori or at runtime). Filters 148 may be specified to select all, none, or a subset of notifications 134 of interest. Filters 148 in any of the stages 110, 166, 122, including the subscription filter stage 116, are also modifiable wholesale (e.g., to suspend/resume filtering, or to modify a filter). Default delivery may be selected for a class of subscribers 126, but it can also be directed to a different subscriber 126 (e.g., by using a combination of subscriber identification and receiving object identification). For example, the original subscriber 126 may choose to route notifications 134 to a different object, such as a logging mechanism.

Finally, as shown in FIG. 1, using the subscriber filter stage 122, which may be located within the subscriber 126, additional specific filtering can take place. For example, fault filters 184 may be applied as part of a fault analysis test to specify, for instance, the identification of a fault based not just on the associated event 138, but on the context of the event 138 (e.g., the number of times this event has occurred within a time period). It should be noted that at each stage 110, 116, 122 of filtering, filters 148 are optional, meaning that the default operation may be set to pass through information 151 or indications 151, and/or notifications 134 associated with the occurrence of events 138 at each stage 110, 116, 122. In addition, the specification or language for individual discriminators 152 (e.g., filtering evaluation criteria) may depend on specific implementations of the apparatus 100 and systems 146, and it may be based on Boolean evaluation conditions. Boolean operator attributes, where appropriate, may also be selected in order to achieve consistency and interoperability of filters 148 across multiple device 146 instantiations.

For example, permanent or static changes to a managed object schema 142 and the structure of associated events 138 can be handled by a simplistic approach of creating or deleting events wholesale. However, circumstances within a platform 146 often arise that require only temporary adjustments to event 138 propagation during platform 146 operation. For instance, during alarm and fault management operations, such as analysis and isolation, it is often advantageous to control the subsystem responsible for generating an alarm while analysis or repair tests are conducted. In addition, since information related to events 138 can propagate across multiple boundaries between software layers (e.g., drivers to middleware to applications to services, and so on), the ability to control notification behavior across such boundaries is also quite desirable. Thus, for example, the apparatus 100 and system 146 may include a fault analysis module 184 to apply a fault filter 148 included in the subscriber filter stage 122. In addition, the apparatus 100 and system 146 may include a reroute filter 188 in the subscriber filter stage 122 to reroute the notification 134 of an event 138 for logging the notification 134 of the event 138 to an event log 180.

The apparatus 100, filter stages 110, 116, 122, subscribers 126, managed objects 130, notifications 134, events 138, managed object repository 142, filters 148, indications 151, discriminators 152, platform resources 153, processor 154, wireless communication device 158, ports 162, applications 163, storage devices 164, volatile and nonvolatile memory 166, OA&M fault management component 176, event log 180, notification log 180, fault filters 184, fault analysis module 184, and reroute filter 188 may all be characterized as “modules” herein. Such modules may include hardware circuitry, and/or one or more processors and/or memory circuits, software program modules, and/or firmware, and combinations thereof, as desired by the architect of the apparatus 100 and the system 146, and as appropriate for particular implementations of various embodiments of the invention.

It should also be understood that the apparatus and systems of various embodiments of the invention can be used in applications other than for computers, and other than for systems that include transmitters, receivers, and transceivers, and thus, embodiments of the invention are not to be so limited. The illustrations of an apparatus 100 and a system 146 are intended to provide a general understanding of the structure of various embodiments of the invention, and they are not intended to serve as a complete description of all the elements and features of apparatus and systems that might make use of the structures described herein.

Applications that may include the novel apparatus and systems of various embodiments of the invention include electronic circuitry used in high-speed computers, communication and signal processing circuitry, modems, processor modules, embedded processors, and application-specific modules, including multilayer, multi-chip modules. Such apparatus and systems may further be included as sub-components within a variety of electronic systems, such as televisions, cellular telephones, personal computers, workstations, radios, video players, vehicles, and others.

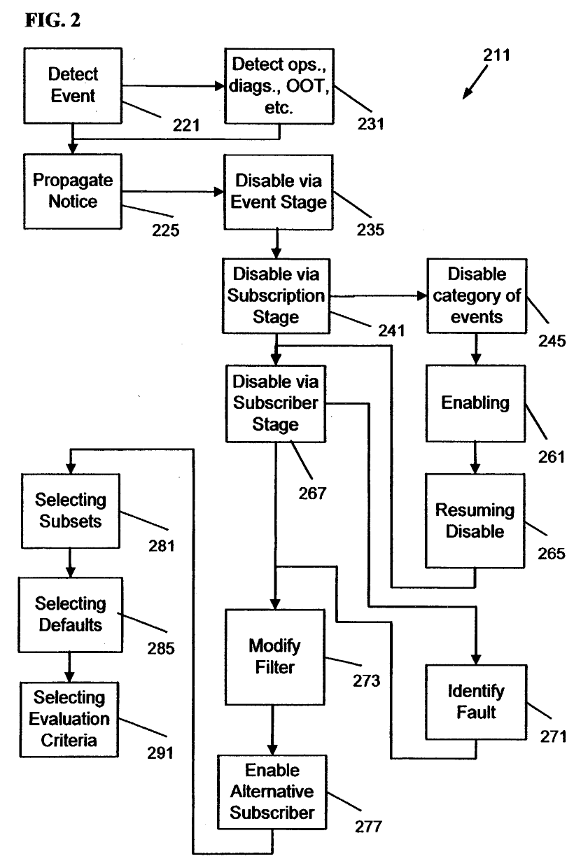

FIG. 2 is a flow chart illustrating several methods, according to various embodiments of the invention. In some embodiments, a method 211 may begin with detecting the occurrence of an event associated with a change in a managed object at block 221, and then propagating a notification of the event to a subscriber at block 225 through a plurality of filter stages including at least two of an event filter stage, a subscription filter stage, and a subscriber filter stage. Detecting the occurrence of the event may further include detecting one or more of: normal platform operations, diagnostics, surveillance, or out-of-tolerance conditions, and the like, at block 231.

Propagating the notification of the event to the subscriber through the plurality of filter stages may include any number of activities, such as disabling propagation of an indication of the occurrence of the event through the event filter stage at block 235, and disabling propagation of the notification of the event through the subscription filter stage at block 241.

Disabling propagation of the notification of the event through the subscription filter stage may also include several activities, such as disabling propagation of a notification of a category of events including the event at block 245, enabling propagation of a notification of a category of events at block 261, and then resuming disabling propagation of the notification of the category of events at block 265.

In addition, propagating the notification of the event to the subscriber through the plurality of filter stages may include disabling propagation of the notification of the event through the subscriber filter stage at block 267, which may include, in turn, identifying a fault associated with the event and an event context at block 271. The event context may be selected from any number of items, including the number of times the event has occurred within a selected time period, whether the event occurs within a selected time period, whether the event is used to increment a counter (e.g., a high water mark for some resource, such as a storage device), whether the event occurred within a selected time period prior to or after another event, etc.

Propagating the notification of the event to the subscriber through the plurality of filter stages further may also include modifying a filter included in a selected one of the plurality of filter stages at block 273, enabling delivery of the notification of the event to an alternative subscriber not included in a class of subscribers including the subscriber at block 277, selecting a subset of notifications of interest including the notification of the event within the subscription filter stage at block 281, enabling propagation of the notification of the event through the event filter stage and the subscription filter stage as a default condition at block 285, and selecting filtering evaluation criteria, such as Boolean evaluation criteria, of notification filtering conditions within at least one of the plurality of filter stages at block 291.

It should be noted that the methods described herein do not have to be executed in the order described, or in any particular order. Moreover, various activities described with respect to the methods identified herein can be executed in serial or parallel fashion. Information, including parameters, commands, operands, and other data, can be sent and received in the form of one or more carrier waves.

Thus, referring back to FIG. 1, it may now be seen that another embodiment of the invention may include an article 146 such as a computer, a memory system, a magnetic or optical disk, some other storage device, and/or any type of electronic device or system, comprising a machine-accessible medium such as a memory 166 (e.g., a memory including an electrical, optical, or electromagnetic conductor) having associated data 190 (e.g., computer program instructions), which when accessed, results in a machine performing such actions as detecting the occurrence of an event associated with a change in a managed object, and propagating a notification of the event to a subscriber through a plurality of filter stages including an event filter stage, a subscription filter stage, and a subscriber filter stage.

Other activities may include selecting a subset of notifications of interest including the notification of the event within the subscription filter stage, enabling propagation of the notification of the event through the event filter stage and the subscription filter stage as a default condition, and selecting filtering evaluation criteria, such as a Boolean evaluation of notification filtering conditions within at least one of the plurality of filter stages.

Although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein, will be apparent to those of skill in the art upon reviewing the above description.

The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

What is claimed is:

1. A method, comprising:
detecting the occurrence of an event associated with a change in a managed object; and
propagating a notification of the event to a subscriber through a plurality of filter stages including at least two of an event filter stage, a subscription filter stage, and a subscriber filter stage.

2. The method of claim 1, wherein detecting the occurrence of the event associated with the change in the managed object further includes:
detecting one or more of normal platform operations, diagnostics, surveillance, or out-of-tolerance conditions.

3. The method of claim 1, wherein propagating the notification of the event to the subscriber through the plurality of filter stages further includes:
disabling propagation of an indication of the occurrence of the event through the event filter stage.

4. The method of claim 1, wherein propagating the notification of event to the subscriber through the plurality of filter stages further includes:
disabling propagation of the notification of the event through the subscription filter stage.

5. The method of claim 4, wherein disabling propagation of the notification of the event through the subscription filter stage further includes:
disabling propagation of a notification of a category of events including the event.

6. The method of claim 5, further comprising:
enabling propagation of a notification of a category of events; and
resuming disabling propagation of the notification of the category of events.

7. The method of claim 1, wherein propagating the notification of the event to the subscriber through the plurality of filter stages further includes:
disabling propagation of the notification of the event through the subscriber filter stage.

8. The method of claim 7, wherein disabling propagation of the notification of the event through the subscriber filter stage further includes:
identifying a fault associated with the event and an event context.

9. The method of claim 8, wherein the event context is selected from at least one of a number of times the event has occurred within a selected time period, whether the event occurs within the selected time period, whether the event is used to increment a counter, and whether the event occurs within a selected time period after another event occurs.

10. The method of claim 1, wherein propagating the notification of the event to the subscriber through the plurality of filter stages further includes:
modifying a filter included in a selected one of the plurality of filter stages.

11. The method of claim 1, wherein propagating the notification of the event to the subscriber through the plurality of filter stages further includes:
enabling delivery of the notification of the event to an alternative subscriber not included in a class of subscribers including the subscriber.

12. An article comprising a machine-accessible medium having associated data, wherein the data, when accessed, results in a machine performing:
detecting the occurrence of an event associated with a change in a managed object; and
propagating a notification of the event to a subscriber through a plurality of filter stages including an event filter stage, a subscription filter stage, and a subscriber filter stage.

13. The article of claim 12, wherein propagating the notification of the event to the subscriber further comprises:
selecting a subset of notifications of interest including the notification of the event within the subscription filter stage.

14. The article of claim 12, wherein propagating the notification of the event to the subscriber further comprises:
enabling propagation of the notification of the event through the event filter stage and the subscription filter stage as a default condition.

15. The article of claim 12, wherein propagating the notification of the event to the subscriber further comprises:
selecting evaluation filtering criteria of notification filtering conditions within at least one of the plurality of filter stages.

16. An apparatus, comprising:
a plurality of filter stages including at least two of an event filter stage, a subscription filter stage, and a subscriber filter stage; and
a subscriber capable of being communicatively coupled to a managed object via the plurality of filter stages, wherein the managed object is associated with a notification of an event capable of propagating through the plurality of filter stages to the subscriber.

17. The apparatus of claim 16, further comprising:
a managed object repository having a plurality of managed objects including the managed object.

18. The apparatus of claim 16, further comprising:
a fault analysis module to apply a fault filter included in the subscriber filter stage.

19. The apparatus of claim 16, wherein the managed object is associated with a physical characteristic of a platform resource.

20. The apparatus of claim 16, wherein the managed object is associated with a dynamic characteristic of a platform resource.

21. The apparatus of claim 16, further comprising:
a filter included in the subscriber filter stage to reroute the notification of the event for logging the notification of the event.

22. A system, comprising:
a processor capable of being communicatively coupled to a memory;
a plurality of filter stages capable of being communicatively coupled to the processor, including at least two of an event filter stage, a subscription filter stage, and a subscriber filter stage;
a subscriber capable of being communicatively coupled to a managed object via the plurality of filter stages, wherein the managed object is associated with a notification of an event capable of propagating through the plurality of filter stages to the subscriber; and
a wireless communication device capable of being communicatively coupled to the processor.

23. The system of claim 22, wherein the memory includes a repository of managed objects including the managed object.

24. The system of claim 22, further comprising:
a filter included in the event filter stage to disable creating a notification of an occurrence of the event.

25. The system of claim 22, further comprising:
a filter included in the subscription filter stage to disable delivery of the notification of the event to the subscriber.
